(19) United States
(12) Patent Application Publication
(10) Pub. No.: US 2025/0251042 A1
(43) Pub. Date: Aug. 7, 2025

(54) END FACE MECHANICAL SEALING DEVICE, END FACE MECHANICAL SEAL, AND METHOD FOR MOUNTING AN END FACE MECHANICAL SEALING DEVICE

(71) Applicant: Frideco AG, Neunkirch (CH)

(72) Inventor: Dieter BRÜHLMANN, Neunkirch (CH)

(21) Appl. No.: 18/854,509

(22) PCT Filed: Mar. 29, 2023
(86) PCT No.: PCT/EP2023/058176

§ 371 Date: Oct. 4, 2024

(30) Foreign Application Priority Data
Apr. 5, 2022 (DE) 10 2022 108 183.4

(51) Int. Cl. F16J 15/36

(52) U.S. Cl. CPC F16J 15/36

(57) ABSTRACT

A mechanical sealing device having comprises an elastic element and a housing unit and further comprises a support element for pretensioning the elastic element in the housing unit.

### PRIOR ART

The invention relates to a mechanical sealing device according to the preamble of claim 1, a mechanical seal according to claim 13, and a method for mounting a mechanical sealing device according to claim 14.

A mechanical seal is already known from the prior art, which comprises a spring and a housing consisting of at least two parts. For pretensioning the spring in the housing, the spring can first be inserted into a first part of the housing, and subsequently a second part of the housing can be connected to the first part of the housing, for example by a screw and/or welded connection. The disadvantage of this procedure for pretensioning the spring is a fragmentation of the housing and a complex mounting, in particular assembly, and/or production of the mechanical seal. Furthermore, it is also known from the prior art, for pretensioning the spring, to use a one-piece housing with a plurality of bores and individual spring parts, specifically multiple springs, wherein the multiple springs can be inserted into the bores of the housing. In this case, too, the disadvantage is a complex and uncomfortable mounting, in particular assembly, and/or production of the mechanical seal, and an increased cost and/or material outlay.

The object of the invention is, in particular, to provide a generic device with improved properties with regard to a design. The object is achieved according to the invention by the features of claims 1, 13 and 14, while advantageous refinements and developments of the invention can be gathered from the subclaims.

### Advantages of the Invention

The invention is based on a mechanical sealing device having an elastic element and a housing unit.

It is proposed that the mechanical sealing device has a support element for pretensioning the elastic element in the housing unit.

By means of such a refinement, a design can be improved and a simple, comfortable, efficient and/or user-friendly design can be provided. In addition, mounting and in particular possibly also dismounting can be optimized and a high degree of ease of mounting and in particular possibly also ease of dismounting can be provided. Furthermore, an outlay, with regard to a mounting outlay and possibly also a dismounting outlay, can be reduced and an efficiency, with regard to a product and/or work and/or cost efficiency, can be increased. Furthermore, mounting, specifically pretensioning of an elastic element in a housing unit, can be made easier and more efficient, with the result that a time outlay, namely specifically during mounting, can be reduced. Furthermore, by means of such a refinement, a mechanical sealing device can be provided which, during use/operation on preferably one shaft, can also be applied under difficult operating conditions, such as, for example, high ambient temperatures, high operating pressure, high shaft rotational speeds/circumferential speeds and/or difficult conveying media. In this way, in turn, a flexibility with regard to possible uses of the mechanical sealing device can be increased. In addition, the mechanical sealing device can preferably be used for shafts with metric dimensions.

Preferably, the mechanical sealing device is part of a mechanical seal and forms a subassembly of the mechanical seal. However, it would also be conceivable for the mechanical sealing device to comprise the entire mechanical seal. In particular, the mechanical seal is provided, without being restricted thereto, for use and/or mounting on a shaft. The shaft can be a drive shaft, preferably a pump shaft. In particular, the shaft is a rotating shaft. The shaft may have one or more shaft groove/shaft grooves extending in the circumferential direction with respect to an axial direction of the shaft, in particular for fixing one or more seals, for example one or more mechanical seals. A “shaft groove” is to be understood as an indentation of the shaft. The shaft groove may extend over an entire circumference of the shaft in the circumferential direction. Advantageously, the shaft groove is formed rotationally symmetrical with respect to the longitudinal axis. Alternatively, the mechanical seal may also be arrangeable on the shaft, which is free of a shaft groove.

The shaft may be provided for use in a drive unit, wherein the drive unit has at least one drive means which sets the shaft into rotation in an operating state. The drive means has, for example, at least one electric motor and/or internal combustion engine and/or a bearing block. Preferably, the shaft is rotatably supported with respect to a remaining drive unit about a longitudinal axis of the shaft, which is oriented parallel to the axial direction, in particular by means of at least one slide bearing and/or roller bearing of the drive unit. Particularly preferably, the shaft executes a rotational movement along the circumferential direction in the operating state. In particular, the shaft is formed as an elongate element and the longitudinal axis of the shaft is oriented parallel to the axial direction. The drive unit may be part of any desired machine system known to the person skilled in the art. Preferably, the drive unit is part of a pump system, for example for conveying fluids.

Preferably, the shaft is coupled to a working unit which has a working means and which is configured to perform work in the operating state. It would be conceivable for the shaft to be indirectly coupled to the working unit, in particular the working means, for example by means of a transmission. Advantageously, the shaft is directly coupled to the working unit, in particular the working means. Preferably, the working unit has a hub for fixing to the shaft. The working means may be formed as any desired working means known to the person skilled in the art. Preferably, the working means is formed as a rotor, in particular a pump rotor. The rotor, in particular the pump rotor, may be part of the pump system. Advantageously, the working unit is part of the machine system, preferably of the pump system. It would possibly also be conceivable for the working unit, in particular the rotor, to function alternatively as a drive unit for driving the shaft.

The mechanical seal may be usable in the machine system, preferably the pump system. The machine system could comprise at least the mechanical seal. In particular, the machine system, in particular the pump system, comprises the shaft. The shaft may be configured to connect the drive unit to the working unit. Preferably, the mechanical seal is configured to seal the shaft, in particular the rotating shaft, at least partially and advantageously completely with respect to a wall, for example a machine housing of the machine system. The mechanical seal serves in particular to seal a working chamber of the machine system, in particular of the pump system, from a surrounding medium and/or a further chamber, in particular an electronics housing of the machine system, in particular of the pump system. The working unit, in particular the rotor, may be arranged at least partially in the working chamber. Advantageously, the drive unit is arranged at least partially in the electronics housing.

It would possibly be conceivable for the machine system, in particular the pump system, to comprise at least two mechanical seals in a tandem arrangement. A first mechanical seal could be arranged on the working side, in particular on the rotor side, on the shaft. A second mechanical seal could be arranged above the first mechanical seal as viewed in the height direction. In particular, the second mechanical seal is arranged on the drive side of the shaft. Due to the position and/or the arrangements of the mechanical seals on the shaft within the machine system, in particular the pump system, the mechanical seals may be exposed to different circumstances and have to meet different requirements for sealing. The sealing requirements of the first mechanical seal may be higher than those of the second mechanical seal, in particular with respect to the aforementioned tandem arrangement. Alternatively, the sealing requirements of the second mechanical seal could also be higher than those of the first mechanical seal. The first mechanical seal and the second mechanical seal can be aligned differently. Particularly preferably, the first mechanical seal according to the described invention is aligned in this document. In addition, at least the second mechanical seal can also comprise an analogous configuration to the first mechanical seal.

The first mechanical seal and the second mechanical seal could each comprise at least identical mechanical sealing devices. The support element according to the present mechanical sealing device is configured for pretensioning the elastic element in the housing unit. Advantageously, the housing unit is formed in one piece, preferably in single-piece. “In one piece” is to be understood as being connected at least in a materially bonded manner, for example by an adhesive bonding process, an injection-molding process and/or welding process and/or another process considered expedient by a person skilled in the art. In the present case, “in single-piece” is to be understood as being formed in one piece. Preferably, this one piece is produced from a single blank, a mass and/or a casting, particularly preferably in an injection-molding process, in particular a single-component and/or multi-component injection-molding process, and/or in a punching process and/or another process considered expedient by the person skilled in the art from the single blank.

The housing unit could consist at least partially or for the most part of a plastic, a mineral, a metal, preferably a stainless steel, particularly preferably with increased acid resistance, and/or a composite material. In the present case, the expression “for the most part” is to be understood as meaning, for example, at least 55%, advantageously at least 65%, preferably at least 75%, particularly preferably at least 85% and particularly advantageously at most 95% of a volume and/or mass fraction. Preferably, the housing unit is produced by means of a turning, drilling and/or milling process, to be precise in particular from a blank.

The housing unit could have at least one or more openings into which in each case at least one corresponding threaded pin of the mechanical seal is preferably reversibly insertable, in particular screwable. The threaded pin can be a grub screw or a worm screw, in particular a head-free screw. The threaded pin can be configured for securing the mechanical sealing device, in particular at least the housing unit, on the shaft against rotation.

In the present case, the “elastic element” is an element which is repeatedly deformable without the element being mechanically damaged or destroyed as a result and which, in particular after a deformation, automatically strives for a basic shape again. In particular, the elastic element is flexible. Preferably, the elastic element is formed as a spring, for example as a spiral spring.

The elastic element can be compressed and thus pretensioned in the housing unit by means of the support element. In a mounted state, the support element and at least the elastic element can be mounted in the housing unit and the elastic element can be pretensioned in the housing unit by means of the support element. The support element can block and/or prevent complete relaxation of the elastic element in the housing unit. In particular, the support element is formed differently from the housing unit. Preferably, the support element and the housing unit are two structural units/components which are separate from one another.

Here and below, “configured” is to be understood as meaning specifically programmed, designed and/or equipped. The fact that an object is configured for a specific function is to be understood as meaning that the object fulfills and/or executes this specific function in at least one application state and/or operating state.

It would be conceivable for the support element for fixing in the housing unit to have at least one latching hook and/or at least one latching lug and/or at least one projection which could advantageously engage in a corresponding element of the housing unit for fixing and/or holding. For example, the support element could be fixable in the housing unit by means of a bayonet connection. Likewise, force-fitting and/or form-fitting and/or integrally bonded connections, such as for example screw and/or adhesive connections, would be conceivable in order to fix the support element in the housing unit. The support element could be fixable permanently, specifically irreversibly, in the housing unit.

The support element could be reversibly insertable into the housing unit and removable from the housing unit. The support element could possibly be removable in a non-destructive manner. Preferably, the support element must be destroyed when removed from the housing unit. In particular, the support element is destroyable when removed from the housing unit. Furthermore, the elastic element can be reversibly insertable into the housing unit and removable from the housing unit, in particular in a non-destructive manner. Furthermore, it is proposed that the housing unit has a recess for accommodating the support element. As a result, a design can be further improved and an accommodation, specifically a holder and/or fixing of a support element in a housing unit, can be provided. In this way, a safety for an operator and/or fitter can be increased. In addition, at least one elastic element can be held in the housing unit by means of the accommodation of the support element in the recess. Furthermore, mounting can be made easier and more comfortable, and therefore in turn an efficiency can be increased and a mounting outlay can be reduced.

The support element can be insertable, preferably latchable, into the recess. During the method for mounting, the support element can be inserted into the recess The recess is configured for receiving the support element in particular in the mounted state. In particular in the mounted state, the support element is inserted, advantageously latched, into the recess. Preferably, the support element arranged in the recess, in particular inserted and/or latched, is configured for preventing at least the elastic element from being released and/or springing out of the housing unit in the mounted state.

In addition, it is proposed that the recess is formed at least in sections, advantageously completely, as an annular groove. As a result, a design can be optimized to the effect that an accommodation, specifically a holder and/or fixing of a support element in a housing unit, can be improved and designed in a safer manner. In addition, a compact and/or simple design can be provided in order to hold and/or fix the support element in the housing unit.

The recess can be formed at least in sections, specifically at least to the extent of 50%, advantageously at least to the extent of 70% and preferably at least to the extent of 80%, as an annular groove in the circumferential direction of the housing unit. Particularly preferably, the recess is formed as an annular groove in the entire circumferential direction of the housing unit.

In principle, configurations of different sizes of the mechanical sealing device, in particular the mechanical seal, can be conceivable, specifically in particular with regard to shaft configurations of different sizes. In particular depending on the shaft diameter of the shaft, mechanical sealing devices of different sizes have to be used. Preferably, the mechanical sealing device is arrangeable and/or usable on shafts with shaft diameters of at least 5 mm. In this document, values for a specific size/configuration of a mechanical sealing device, in particular a mechanical seal, are specified by way of example. Of course, these values can be adapted and/or changed depending on the shaft diameter, specifically in such a way that the mechanical sealing device is arrangeable on the shaft with the respective shaft diameter. In addition, for the value ranges specified in this document, values lying within the aforementioned limits should also be considered as disclosed and usable as desired.

For example, the housing unit can have an inner diameter of at least 10 mm, advantageously of at least 30 mm and preferably of at least 60 mm. Furthermore, the inner diameter of the housing unit can be at most 120 mm, advantageously at most 160 mm and preferably at most 200 mm. An outer diameter of the housing unit could be, for example, at least 15 mm, in particular at least 35 mm, advantageously at least 60 mm and preferably at least 120 mm. The outer diameter of the housing unit could have a value of at most 150 mm, advantageously at most 200 mm and preferably at most 260 mm. The recess formed as a groove can have a width of at least 0.3 mm, advantageously at least 0.5 mm and preferably of at most 4 mm.

When inserting at least the support element into the housing unit, at least the support element can slide at least in sections along a surface, in particular an inner surface, of the housing unit. The inner surface can be a surface of the housing unit on an inner side of the housing unit. During insertion, at least the support element could be able to be guided at least in sections along the inner surface of the housing unit.

If the housing unit has at least one surface section for guiding the support element during insertion into the housing unit, mounting can be made easier, a mounting outlay can be reduced and a comfort can be increased. Furthermore, an improved design can be provided. In addition, destruction and/or wear of the support element during insertion into the housing unit can be reduced and advantageously prevented.

Preferably, the surface section is part of the inner surface. The surface section could directly adjoin at least one further surface section of the housing unit, in particular on the inner surface. The surface section and at least the further surface section could have the same surface properties. It would also be conceivable for the surface section and the further surface section to have different surface properties. The surface property could, for example, involve smooth or rough characteristics.

At least the surface section is configured for assisting guidance of the support element during insertion into the housing unit, specifically preferably during insertion of the support element into the recess. During insertion, at least the support element could slide along at least the further surface section. Advantageously, at least the support element slides along the surface section during insertion, in particular after the further surface section. In the method for mounting, the support element can be pushed along the surface section in order to be inserted into the recess. In particular, in the method for mounting, at least the support element is pushed along the further surface section and subsequently along the surface section.

The surface section could be arranged spaced apart from the recess in the housing unit. Advantageously, the surface section at least in sections directly, in particular directly, adjoins the recess. For guiding the support element during insertion into the housing unit, advantageously into the recess, the surface section can have a slope/inclination with respect to a further surface section, in particular depending on the viewing. Preferably, the housing unit comprises a concentric reduction in the surface section. The reduction can be referred to as a cone and advantageously as a conical part. In particular, the reduction is formed as a conical transition piece. An angle of inclination, in particular a one-sided angle of inclination, could have at least 5°, advantageously at least 8°, preferably at least 10° and particularly preferably at least 12°. Preferably, the angle of inclination is at most 15° and in particular at most 20°.

If the support element abuts at least in sections against an outer radial edge of the housing unit, a compact design can be provided and advantageously a support element can be arranged in a simple and efficient manner in a housing unit. In particular, the outer radial edge is an outer edge on the inner surface of the housing unit.

In order to further improve a design and to further simplify mounting and/or make it more comfortable, it is proposed that the support element is deformable for insertion into the housing unit. In addition, a longevity of a support element can thus be improved and the support element can be inserted repeatedly into a housing unit. In this way, in turn, costs, with regard to material and/or production costs, can be reduced. Advantageously, the support element is deformable in a non-destructive manner during insertion into the housing unit. It would also be conceivable for at least the housing unit additionally to be deformable during insertion of at least the support element. The support element can be deformable in such a way that it is insertable into the recess.

The support element can be formed corresponding to the recess. Preferably, the support element has an annular shape at least in sections, preferably completely. Therefore, a design can be increased with regard to compactness and/or efficiency. The support element can have an annular shape at least in sections, specifically at least to the extent of 50%, advantageously at least to the extent of 70% and preferably at least to the extent of 80%, in the circumferential direction.

In a preferred refinement of the invention, it is proposed that the support element is formed in a disc-like manner. As a result, a particularly simple and/or thin and/or flat and/or space-saving support element can be provided. In addition, an outlay, with regard to a production outlay, and material costs can be reduced. Furthermore, a design can be further optimized as a result. The support element can abut in the recess at least partially in a contact- and/or surface-flush manner against the side walls of the recess on both sides. Preferably, the support element is inserted in the recess in a contact- and surface-flush manner. The support element can have a thickness of at least 0.2 mm, advantageously at least 0.3 mm and preferably at least 0.5 mm. Preferably, the support element has a thickness of at most 1 mm, in particular at most 3 mm, particularly preferably of at most 4 mm.

Furthermore, it is proposed that the mechanical sealing device has an intermediate element for transmitting force to the elastic element, which intermediate element is arranged between the elastic element and the support element. As a result, a design can be further optimized and specifically a direct contact between a support element and an elastic element can be avoided/prevented. Furthermore, preferably by means of an intermediate element, forces, in particular torques, during operation/use of a mechanical seal can be transmitted from a sealing element, specifically preferably a slide ring, of the mechanical seal via the intermediate element to a housing unit of a mechanical sealing device. In addition, a fixing of the sealing element, specifically preferably of the slide ring, in the housing unit can advantageously be provided by means of the intermediate element. Furthermore, rotations of the sealing element during use/operation of the mechanical seal, for example on a shaft, can be prevented by means of the intermediate element. In this way, in turn, a safety can be increased.

The intermediate element can be formed in a disc-like manner. The intermediate element can have an annular shape. In particular, the intermediate element is formed differently from the housing unit. Particularly preferably, the intermediate element is a driver disc. When inserting the elastic element and the support element into the housing unit, the intermediate element can be arranged between the elastic element and the support element. The intermediate element can have a direct contact with the elastic element at least during insertion into the housing unit. In particular, the intermediate element is configured for transmitting a force starting from the support element to the elastic element during insertion and in particular for compressing the elastic element due to the direct contact during insertion. In the method for mounting the mechanical sealing device, the intermediate element could be placed on the elastic element and the support element could be placed on the intermediate element and subsequently the elastic element, the intermediate element, and the support element could be inserted together into the housing unit. Alternatively, the elastic element and the intermediate element can be inserted into the housing unit and subsequently the support element can be pressed into the housing unit, specifically preferably into the recess. In particular in the mounted state, the elastic element, the intermediate element, and at least the support element are inserted and/or mounted into the housing unit.

It would be conceivable for the intermediate element to be held in the housing unit in the mounted state only by means of the support element. Alternatively, the intermediate element for holding and/or fixing the intermediate element in the housing unit can have at least one fixing element or a plurality of fixing elements.

Furthermore, the mechanical seal can comprise at least one sealing element. The sealing element could be an at least partially rotatable sealing element, in particular a rotatable sealing ring. Particularly preferably, the sealing element is a slide ring. The sealing element could be at least partially insertable into the housing unit. The sealing element can abut at least in sections against the intermediate element, in particular in at least the mounted state. The mechanical seal could also have further sealing elements, for example one or more secondary seals. The secondary seal can be, for example, an O-ring. It would be conceivable for at least one secondary seal to likewise be insertable into the housing unit, specifically advantageously simultaneously with the sealing element, during insertion of the sealing element into the housing unit. The secondary seal could be arranged, for example, between the housing unit and/or the support element and/or the sealing element. Preferably, the secondary seal abuts against the housing unit, in particular at least in sections against the surface section and/or the further surface section, and/or the support element and/or the sealing element.

The sealing element, in particular the slide ring, can consist at least partially and advantageously at least for the most part of a mineral and/or a metal, advantageously a semimetal and/or a plastic and/or a chemical compound and/or a composite material.

Furthermore, it is proposed that the support element has a direct contact with the intermediate element at least during insertion into the housing unit. As a result, an optimum transmission of force from a support element to the elastic element can be provided during insertion. In addition, mounting can be made easier and therefore an outlay can be reduced and an efficiency, with regard to a work and/or product and/or cost efficiency, can be increased. In addition, a compact design can be provided.

In addition, it is proposed that the elastic element presses the intermediate element in the direction of the support element. As a result, a design can be further improved and an optimum force and/or sealing effect during mounting/use/operation of the mechanical seal, in particular on a shaft, can be provided.

In the mounted state, the support element can be arranged in the recess and the intermediate element can abut in a contact- and/or surface-flush manner against the intermediate element. In particular, the elastic element presses the intermediate element directly against the support element in the mounted state. Preferably, the support element arranged in the recess, in particular inserted and/or latched, is configured for preventing at least the intermediate element from being released and/or springing out of the housing unit in the mounted state.

Preferably, the mounted state is understood to mean a state which is present before the mechanical seal is mounted and/or arranged on a shaft. In the mounted state, the support element can pretension the elastic element in the housing unit, but a final installation position and thus a final position and/or location of the elastic element and/or of the intermediate element within the housing unit still protrude. In particular, the final installation position is a position and/or location which the intermediate element and/or the elastic element and/or at least the sealing element comprise when the mechanical seal is assembled and/or arranged on the shaft, in particular during operation. Preferably, the final installation position can be reached and/or is present only during mounting/use of the mechanical seal on the shaft.

Furthermore, it is proposed that the intermediate element is movably supported relative to the support element. As a result, a particularly comfortable, simple and/or efficient design can be provided. In addition, ease of mounting can be increased and an outlay, with regard to a mounting outlay, can be reduced. Furthermore, tolerances, for example manufacturing tolerances, can be compensated. Furthermore, an efficient and comfortable adaptation to a final installation position during mounting and/or use of a mechanical seal on a shaft can be provided.

Depending on the tension, in particular pretensioning, of the elastic element, the intermediate element can move relative to the support element. In the final installation position, the intermediate element can be arranged spaced apart from the support element. In a final installation position, a distance of at least 0.5 mm, advantageously at least 1 mm, preferably at least 1.5 mm and particularly preferably at least 3 mm could be present between the intermediate element and the support element.

The mechanical seal can comprise a counter sealing element. Preferably, the counter sealing element is formed as a counter sealing ring. The counter sealing element, in particular the counter sealing ring, can consist at least partially and advantageously at least for the most part of a mineral and/or a metal, advantageously a semimetal and/or a plastic and/or a chemical compound and/or a composite material. In at least the final installation position, the sealing element can abut against the counter sealing element.

Furthermore, the invention is based on a method for mounting a mechanical sealing device, in particular the aforementioned mechanical sealing device, having a housing unit and an elastic element, which is inserted into the housing unit and is pretensioned in the housing unit by means of a support element. By means of such a method, a mounting can be improved. Furthermore, a high degree of ease of mounting can be provided. In addition, an outlay, with regard to a mounting outlay, can be reduced and an efficiency, with regard to a product and/or work and/or cost efficiency, can be increased.

The mechanical sealing device and/or the mechanical seal and/or the method is/are not intended to be restricted here to the above-described use and embodiment. In particular, the mechanical sealing device and/or the mechanical seal and/or the method may have a number of individual elements, components, units and method steps deviating from a number mentioned herein for fulfilling a functionality described herein.

### DRAWINGS

Further advantages result from the following description of the drawings. An exemplary embodiment of the invention is illustrated in the drawings. The drawings, the description and the claims contain numerous features in combination. The person skilled in the art will expediently also consider the features individually and combine them to form expedient further combinations.

In the drawings:

FIG. 1 shows a mechanical seal with a mechanical sealing device,

FIG. 2 shows the mechanical seal according to FIG. 1 in an exploded illustration,

FIG. 3 shows the mechanical seal according to FIG. 1 in a sectional view,

FIG. 4 shows the mechanical sealing device in an exploded illustration,

FIG. 5 shows the mechanical sealing device in an assembled state, and

FIG. 6 shows a schematic method flow diagram for illustrating a method for mounting a mechanical sealing device.

### DESCRIPTION OF THE EXEMPLARY EMBODIMENT

In the following, the present figures are schematic illustrations that are not true to scale. Unless specified otherwise, only one of multiple objects that are present is provided with a reference sign and is described in more detail below.

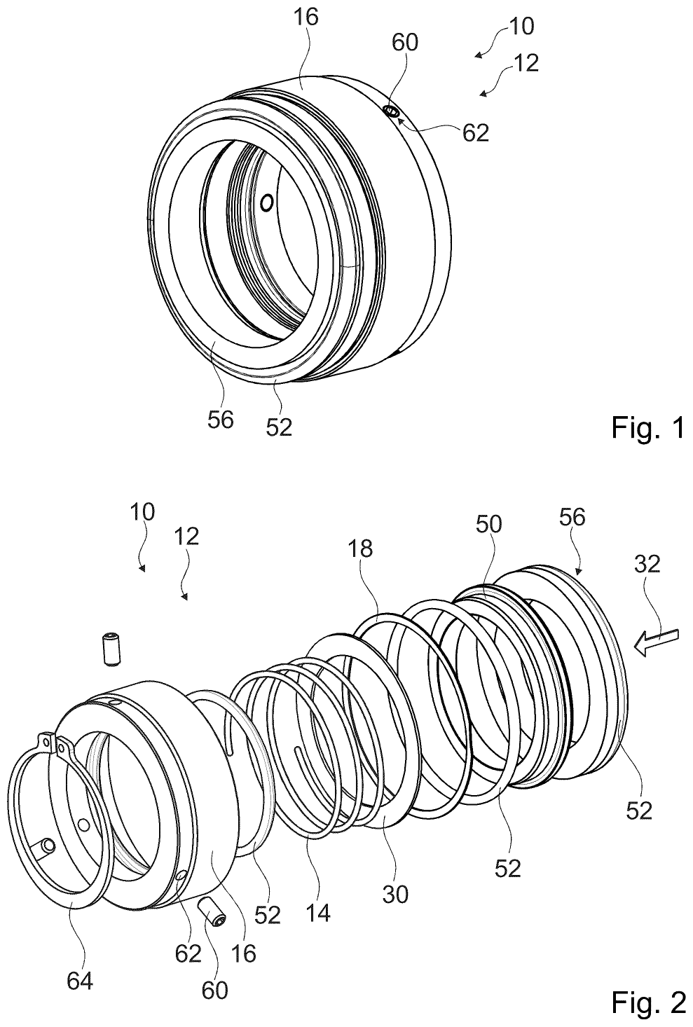

FIG. 1 shows a mechanical seal 10 with a mechanical sealing device 12. According to FIG. 1, the mechanical seal 10 is illustrated in a mounted state, specifically in an assembled state. The mechanical seal 10 is provided for use and/or mounting on a shaft (not illustrated). Furthermore, the mechanical seal 10 is configured to seal the shaft, specifically a rotating shaft, at least partially and advantageously completely with respect to a wall, for example a machine housing of a machine system, preferably of a pump system (not illustrated).

For better understanding of a construction/assembly of the mechanical seal 10, FIG. 2 illustrates an exploded illustration of the mechanical seal 10 according to FIG. 1, which is described in more detail below.

The mechanical seal 10 comprises a clamping ring 64. The mechanical sealing device 12 comprises a housing unit 16. The housing unit 16 comprises at least one opening 62 into which a threaded pin 60, for example a grub screw, is insertable. In this exemplary embodiment, the housing unit 16 comprises three openings 62.

Furthermore, the mechanical sealing device 12 comprises an elastic element 14. In the present case, the elastic element 14 is formed as a spring, specifically as a spiral spring by way of example. According to FIG. 2, an intermediate element 30 of the mechanical sealing device 12 is illustrated behind the elastic element 14. The intermediate element 30 is formed in a disc-like manner. In the present case, the intermediate element 30 is a driver disc. The intermediate element 30 has an annular shape and is formed symmetrically.

For pretensioning the elastic element 14 in the housing unit 16, the mechanical sealing device 12 comprises a support element 18. The support element 18 has an annular shape at least in sections, specifically preferably completely. Furthermore, the support element 18 is formed in a disc-like manner. The support element will be discussed in more detail below.

According to FIG. 2, the mechanical seal 10 comprises a sealing element 50. In the present case, the sealing element 50 is an at least partially rotating sealing ring, specifically a slide ring. The mechanical seal 10 comprises one or more secondary seals 52. In this exemplary embodiment, the mechanical seal 10 comprises at least three secondary seals 52. Here, the secondary seal 52 is formed as an O-ring.

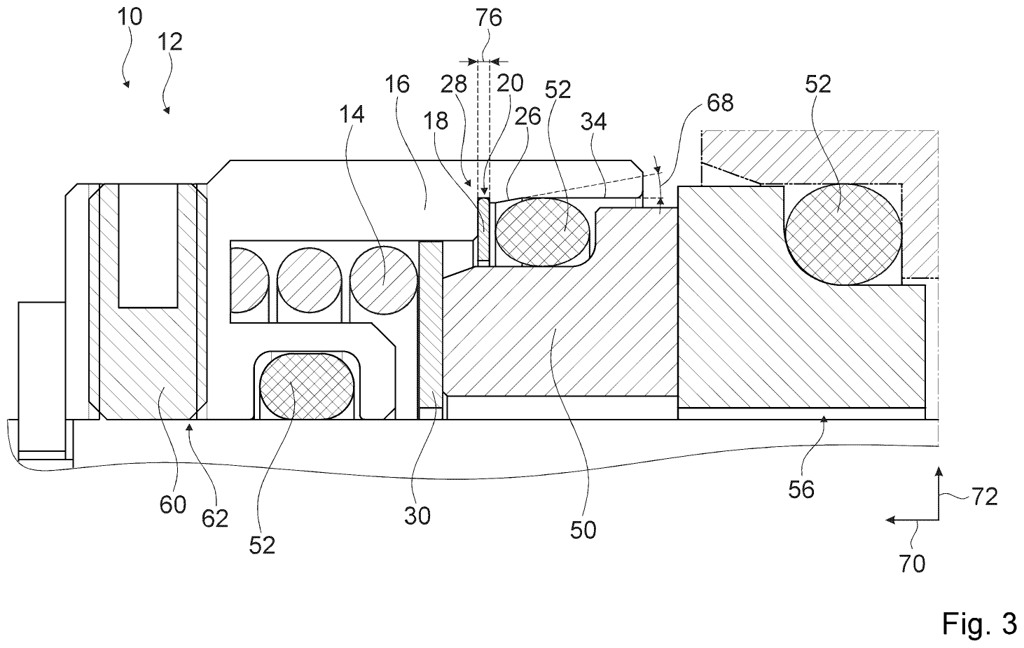

Furthermore, the mechanical seal 10 comprises a counter sealing element 56. In the present case, the counter sealing element 56 is formed as a counter sealing ring. According to FIG. 2, one of the secondary seals 52 is arranged on the counter sealing element 56. Furthermore, the counter sealing element 56 buts against the sealing element 50 (cf. FIG. 3). In the present case, one of the secondary seals 52 is part of the counter sealing element 56.

FIG. 2 shows a mounting direction 32 in which the components/structural units for mounting the mechanical sealing device 12, furthermore the mechanical seal 10, are assembled/can be mounted one after the other.

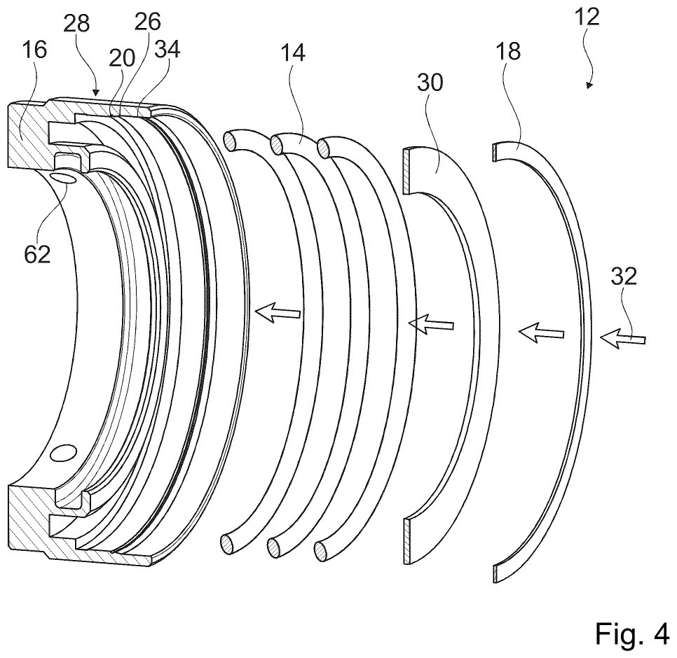

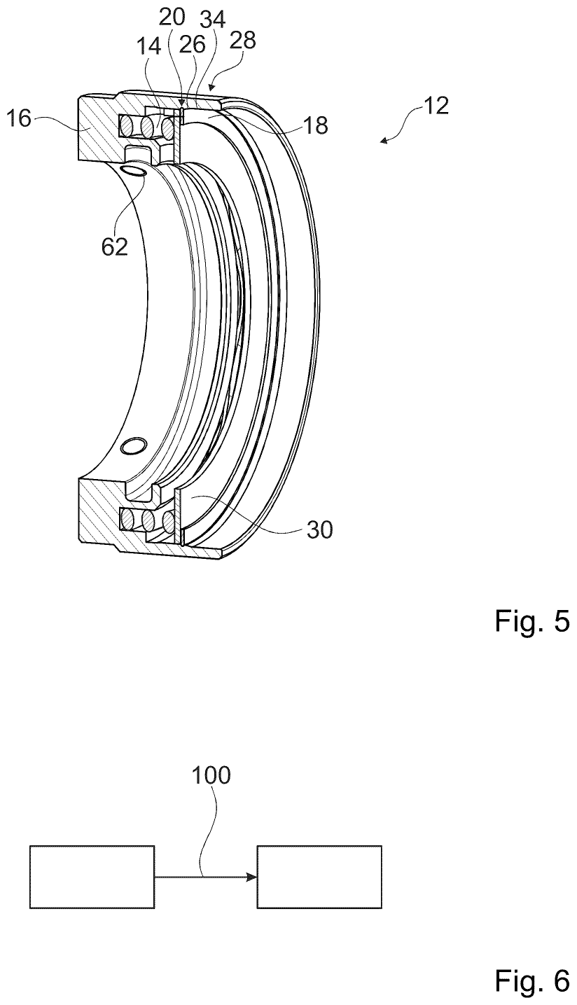

While FIG. 3 illustrates a sectional illustration of the entire mechanical seal 10 with the mechanical sealing device 12 according to FIG. 1, mounting of the mechanical sealing device 12 will be explained in more detail by means of FIGS. 4 and 5. Furthermore, a schematic flow diagram of a method for mounting the mechanical sealing device 12 is illustrated in FIG. 6. In the present case, the method is described by way of example only on the basis of a mounting step 100.

In the mounting step 100, the elastic element 14 is inserted into the housing unit 16 and pretensioned in the housing unit 16 by means of the support element 18. The elastic element 14, the intermediate element 30 and/or the support element 18 are insertable into the housing unit 16 along the mounting direction 32 shown in FIG. 4. In the mounting step 100, either first the intermediate element 30 can be placed on the elastic element 14 and then both elements can be pressed together into the housing unit 16 and only subsequently the support element 18 can be inserted into the housing unit 16 or alternatively the support element 18, the intermediate element 30, and the elastic element 14 are simultaneously arranged together in the housing unit 16, specifically inserted into the housing unit 16.

The housing unit 16 comprises a recess 20 for accommodating the support element 18 (cf. FIGS. 3 to 5). The recess 20 is formed at least in sections and in the present case completely as an annular groove. In this exemplary embodiment, the recess 20 formed as a groove has a width 76 of at least 0.5 mm.

In a mounted state of the mechanical sealing device 12 according to FIG. 5, the support element 18 is inserted into the recess 20, specifically latched. In the present case, the support element 18 abuts at least in sections against an outer radial edge 28 of the housing unit 16. The support element 18 arranged in the recess 20 prevents the intermediate element 30 and the elastic element 14 from being released and/or springing out of the housing unit 16. For insertion into the housing unit 16, specifically in the present case into the recess 20, the support element is deformable. In addition, it may also be conceivable for the housing unit 16 and/or the intermediate element 30 to be deformable.

For guiding the support element 18, specifically for improved and/or more comfortable insertion of the support element 18 into the housing unit 16, the housing unit 16 comprises at least one surface section 26. Furthermore, the surface section 26 is configured for guiding the support element 18 into the recess 20. In addition, the surface section 26 can also be configured for improved and/or more comfortable disassembly of the support element 18 from the housing unit 16, preferably out of the recess 20.

In the present case, the surface section 26 at least in sections directly adjoins the recess 20. The housing unit 16 comprises at least one further surface section 34. In the present case, the further surface section 34 directly adjoins the surface section 26. Viewed in the mounting direction 32, during insertion, the support element 18 first slides along the further surface section 34 and subsequently along the surface section 26. In the mounting step 100, at least the support element 18 is pushed along the further surface section 34 and subsequently along the surface section 26.

For guiding the support element 18 during insertion into the housing unit 16, specifically in the present case into the recess 20, the surface section 26 comprises a concentric reduction in relation to a further surface section 34. The reduction can be referred to as a cone and furthermore as a conical part. In the present case, the reduction is formed as a conical transition piece. An angle of inclination 68 in this exemplary embodiment is at least 10°.

According to FIGS. 2 to 5, it can be seen that the intermediate element 30 is arranged between the elastic element 14 and the support element 18. The support element 18 has a direct contact with the intermediate element 30 at least during insertion into the housing unit 16. In this exemplary embodiment, at least during insertion, the support element 18 contacts only the intermediate element 30, which in turn has a direct contact with the elastic element 14. The intermediate element 30 is configured for transmitting force to the elastic element 14. At least during insertion, a force is transmitted starting from the support element 18 to the intermediate element 30 and by means of the intermediate element 30 to the elastic element 14. Due to the aforementioned transmission of force, the elastic element 14 is at least partially compressed and inserted into the housing in the mounting step 100.

In the mounted state of the mechanical sealing device 12 according to FIG. 5, the elastic element 14, the intermediate element 30, and the support element 18 are inserted into the housing unit 16. The elastic element 14 is pretensioned in at least the assembled state. FIG. 5 shows that the elastic element 14 presses the intermediate element 30 in the direction of the support element 18. In the present case, the intermediate element 30 is movably supported relative to the support element 18. In the mounted state, the intermediate element 30 abuts against the support element 18. The elastic element 14 presses the intermediate element 30 against the support element 18 (cf. FIG. 5). In the presently mounted state, a final installation position of the intermediate element 30 and/or of the elastic element 14 still pends. The final installation position is illustrated in FIG. 3, wherein the intermediate element 30 and the support element 18 are arranged spaced apart from one another.

During further assembly of the mechanical seal 10, at least the sealing element 50 is inserted into the housing unit 16. In this exemplary embodiment, the sealing element 50 is insertable into the housing unit 16 together with one of the secondary seals 52. Along the mounting direction 32, at least the sealing element 50 is inserted into the housing unit 16, specifically until the sealing element 50 contacts the intermediate element 30 at least in sections (cf. FIG. 3). Furthermore, the counter sealing element 56 is arrangeable on the sealing element 50. In the present case, the final installation position can be reached only during mounting/use of the mechanical seal 10 on the shaft.

The cross section shown in FIG. 3 illustrates the final installation position. Here, the sealing element 50 presses the elastic element 14 further together and spaces apart the intermediate element 30 from the support element 18 as a result of the pressure on the intermediate element 30. In the final installation position, the intermediate element 30 is arranged spaced apart from the support element 18. A width direction 70 and a height direction 72 are indicated in FIG. 3. Viewed in the width direction 70, the intermediate element 30 is arranged spaced apart from the support element 18 in the final installation position. Furthermore, according to FIG. 3, it can be seen that the support element 18 is arranged at least partially above the intermediate element 30 and/or the elastic element 14 as viewed in the height direction 72.

During mounting/use of the mechanical seal 10 on the shaft, the sealing element 50 is pressed further into the housing unit 16, with the result that the intermediate element 30 is removed/pushed away from the support element 18. The sealing element 50 presses the intermediate element 30 away from the support element 18 in the mounting direction 32. Furthermore, the sealing element 50 presses the intermediate element 30 in the direction of the elastic element 14 and thereby compresses the elastic element 14 further. During operation of the shaft and during arrangement/use of the mechanical seal 10 on the shaft, specifically the rotating shaft, the intermediate element 30 is movably supported and can be movable axially, specifically relative to the support element 18, due to the elastic element 14 and the sealing element 50.

Due to such a refinement of the mechanical sealing device 12, furthermore the mechanical seal 10, the mechanical sealing device 12, furthermore the mechanical seal 10, can also be used under difficult operating conditions, such as, for example, high ambient temperatures, high operating pressure, high shaft rotational speeds/circumferential speeds and/or difficult conveying media on the shaft.

### REFERENCE SIGNS

10 mechanical seal
12 mechanical sealing device
14 elastic element
16 housing unit
18 support element
20 recess
26 surface section
28 edge
30 intermediate element
32 mounting direction
34 surface section
50 sealing element
52 secondary seal
56 counter sealing element
60 threaded pin
62 opening
64 clamping ring
68 angle
70 width direction
72 height direction
76 width
100 mounting step

1. A mechanical sealing device having an elastic element and a housing unit, further comprising a support element for pretensioning the elastic element in the housing unit.

2. The mechanical sealing device according to claim 1, wherein the housing unit has a recess for accommodating the support element.

3. The mechanical sealing device according to claim 2, wherein the recess is formed at least in sections as an annular groove.

4. The mechanical sealing device according to claim 1, wherein the housing unit has at least one surface section for guiding the support element during insertion into the housing unit-.

5. The mechanical sealing device according to claim 1, wherein the support element is deformable for insertion into the housing unit.

6. The mechanical sealing device according to claim 1, wherein the support element has an annular shape at least in sections.

7. The mechanical sealing device according to claim 1, wherein the support element is formed in a disc-like manner.

8. The mechanical sealing device according to claim 1, wherein the support element abuts at least in sections against an outer radial edge of the housing unit.

9. The mechanical sealing device according to claim 1, characterized by further comprising an intermediate element for transmitting force to the elastic element, which intermediate element is arranged between the elastic element and the support element.

10. The mechanical sealing device according to claim 9, wherein the support element has a direct contact with the intermediate element at least during insertion into the housing unit.

11. The mechanical sealing device according to claim 9, wherein the elastic element presses the intermediate element in the direction of the support element.

12. The mechanical sealing device according to claim 9 wherein the intermediate element is movably supported relative to the support element.

13. A mechanical seal having a mechanical sealing device according to claim 1.

14. A method for mounting a mechanical sealing device having a housing unit and an elastic element, which is inserted into the housing unit and is pretensioned in the housing unit by means of a support element.
